(19) United States
(12) Patent Application Publication
(10) Pub. No.: US 2011/0173784 A1
(43) Pub. Date: Jul. 21, 2011

(54) PAPER BINDING ASSEMBLY

(76) Inventors: Mark E. Mader, North Providence, RI (US); Frank H. Iannucci, JR., North Providence, RI (US); Edward Iannone, JR., Providence, RI (US)

(21) Appl. No.: 12/691,105

(22) Filed: Jan. 21, 2010

(51) Int. Cl. B42F 1/12; B42F 1/04; B42F 1/08; G09F 3/00

(52) U.S. Cl. 24/67 CF; 40/299.01

(57) ABSTRACT

A binding assembly is provided that is applied to the corner of a plurality of loose sheets of paper to secure them in a unitary fashion and facilitates their being hung on a bulletin board or the like. The paper binder clip is constructed of a sheet material metallic body capable of being bent and when bent will remain in the bent position. The binder clip body is placed against sheets of paper that are to be secured together, the corners are bent over the edges of the paper and the body is bent in a manner that also folds over the paper corners. When the paper is received in the binder clip a tab remains straight and extends outwardly from the binder clip. The tab preferably includes a hole therein that facilitates hanging of the binder clip and the sheets of paper secured therein.

### BACKGROUND OF THE INVENTION

The present invention relates generally to a binding assembly that secures a plurality of loose sheets of paper to one another and allows them to be suspended therefrom. More specifically, the present invention provides for a binding assembly that is applied to the corner of a plurality of sheets of paper in a manner that holds the papers together in a unitary fashion and facilitates their being hung on a bulletin board or the like.

The use of paper clips or paper fasteners has long been known. A typical prior art paper clip is made of wire that is bent to form two or more adjacent loops wherein a plurality of sheets of paper are positioned between the loops of the wire clip thereby binding the sheets of paper together. Paper clips, in all their varied forms, function to hold individual papers together as a temporary attachment device that can be readily removed. While paper clips operate generally well, they have drawbacks. For example, paper clips do not have the capability of keeping the group of papers aligned evenly along the top and side surfaces, as the securing mechanism does not have structured means to provide such alignment. Further, they can easily be dislodged as the stack of paper is moved or handled. Still further, if the paper clip is used to suspend the paper, it is highly likely that the papers will slide out and fall therefrom.

Another type of paper fastener punches aligned holes through the pieces of paper. To bind the papers a binding means such as a spine, wound spring or string type of fastening arrangement is passed through the holes. However, this particular type of arrangement has the undesirable feature of mutilating the sheets of paper, which is not particularly attractive when used in conjunction with business letters or legal documents. Further, such binding tends to be relatively permanent, in that the papers cannot be easily separated.

Still another exceedingly common used paper fastener is a staple. Staples are more of a semi-permanent device to affix loose papers in a more secure manner. The staple is a bent wire that actually punctures through the sheets of paper. Once the wire is punctured through the paper it is bent over against the back of the paper thereby binding the sheets of paper together. A staple, however, is not a particularly attractive paper fastener. Also the staple utilizes the undesirable feature of puncturing the sheets of paper forming holes. While staples can hold a stack of paper in a previously established alignment, removing a staple is often problematic. In order to separate papers or documents affixed together by a staple, more effort is needed to pull the staple from the papers because of its secure installation. Once removed, the staple leaves holes in the paper and often creates tears in the paper during removal.

There is therefore a need for a binding assembly that secures a plurality of loose sheets of paper to one another in a neat, organized, semi-permanent fashion that also allows them to be suspended therefrom. There is a further need for a binding assembly that is applied to the corner of a plurality of sheets of paper in a manner that holds the papers together in a unitary fashion and facilitates their being hung on a bulletin board or the like.

### BRIEF SUMMARY OF THE INVENTION

In this regard, the present invention provides a binding assembly that is applied to the corner of a plurality of loose sheets of paper in a manner that secures them in a unitary fashion and facilitates their being suspended therefrom for hanging on a bulletin board or the like.

Generally, the present invention is directed to a paper clip constructed of a sheet material metallic body which is basically rigid in shape but is capable of being bent and when bent will remain in the bent position. The body is primarily of a rectangular or square configuration with the exception that one side may be formed as rounded, triangular or as any other suitable abstract shape so as to operate in an ornamental fashion. This one side will become the front of the clip to be placed against the front side or outer side of the sheets of paper that are to be secured together. The substantially squared corner sections opposite the ornamental portion of the body are to be bent over against the remaining portion of the body forming guide legs which are to be located against the back side or back surface of the sheets of paper. Once installed onto the corner of the paper, the body is then further bent so that the corner of the sheets of paper held within the guide legs are folded between the two folded portions of the body binding the sheets of paper between the inside surface of the front of the body and the outside surface of the guide legs.

Further, an opening is provided that creates a tab centrally within the body portion adjacent to the location wherein the body is folded when the paper id received therein such that when the body portion is folded the tab remains straight and extends outwardly from the binder clip. The tab preferably includes a hole therein that facilitates hanging of the binder clip and the sheets of paper secured therein.

Accordingly, it is an objective of the present invention is to provide a paper binder clip or paper fastener that functions to hold a substantial number of sheets together in a secure manner without injuring the documents while facilitating the hanging thereof. It is a further object of the present invention to provide a binding assembly that secures a plurality of loose sheets of paper to one another in a neat, organized, semi-permanent fashion that also allows them to be suspended therefrom. It is still a further object of the present invention to provide a binding assembly that is applied to the corner of a plurality of sheets of paper in a manner that holds the papers together in a unitary fashion and facilitates their being hung on a bulletin board or the like.

A further object of the present invention is to construct a paper binder clip that is attractive in appearance thereby being an attractive addition to any papers to which it is attached.

Yet a further object of the present invention is to construct a paper clip or paper fastener that is capable of including a personalization logo or advertizing indicia.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a top view of a binder clip in accordance with the teachings of the present invention;

FIG. 2 is a perspective view of the binder clip placed onto the corner of a plurality of sheets to be fastened;

FIG. 3 is a perspective view of the binder clip of FIG. 2 bent over the corner of the documents binding them together; and

FIG. 4 is a top view depicting various other shapes in which the binder clip of the present invention may be formed.

### DETAILED DESCRIPTION OF THE INVENTION

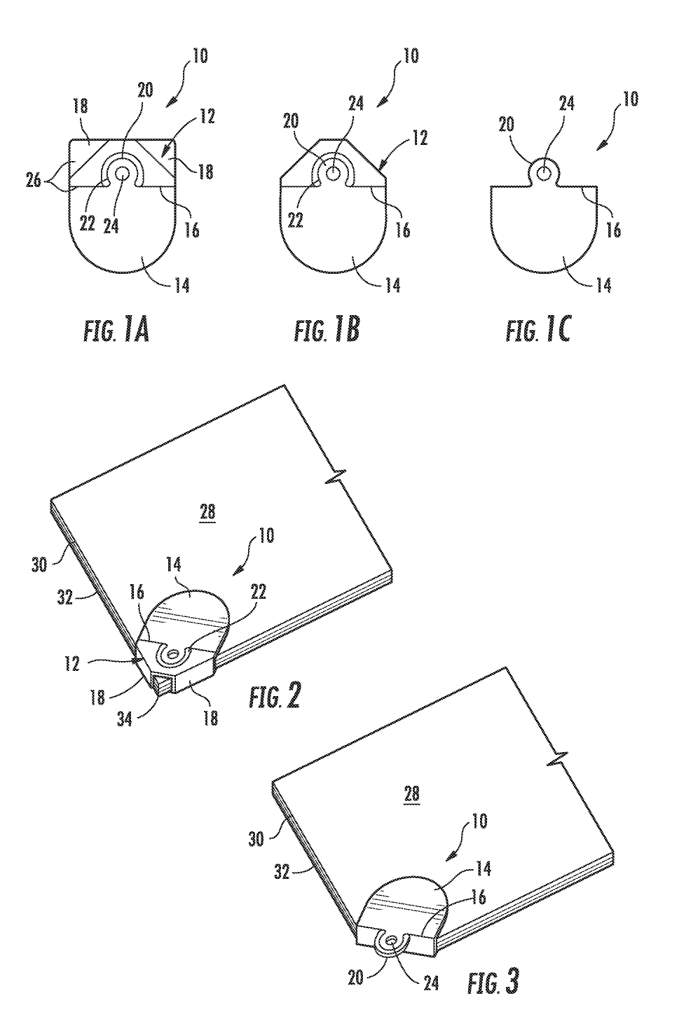

Now referring to the drawings, the paper binding clip of the present invention is shown and generally illustrated in the figures. As can best be seen at FIG. 1, the present invention is most generally directed to a paper binding clip 10 for binding a corner of a stack that contains a plurality of sheets of paper, such that the stack of paper has at least a front sheet and a rear sheet and preferably additional sheets positioned therebetween. The paper binder clip 10 has a body that includes a top portion 12, a bottom portion 14 and a fold line 16 between the top 12 and bottom 14 portions. Guide legs 18 extending from the top portion 12 of the body that are bent rearwardly adjacent the stack of paper as will be described in more detail below and the top portion 12 is bent rearwardly relative to the bottom portion 14 along the fold line 16 thereby trapping and folding the corner of the stack of paper against the bottom of the rear sheet binding the stack therein. A tab 20 extends from the bottom portion 14 of the binder clip 10 body at the fold line 16 such that the tab 20 extends outwardly from the binder clip 10 body when the top portion 12 is bent against the rear sheet of the stack.

The binder clip 10 is preferably constructed of a manually bendable metal material. More preferably, the binder clip 10 is formed from a sheet material metallic body which is basically rigid in shape but is capable of being manually bent and when bent will remain in the bent position. The body is primarily of a rectangular or square configuration with the exception that the bottom portion 14 as depicted at FIG. 4 may be formed in a shape selected from the group consisting of: circular, semicircular, triangular, rectangular and free form so as to operate in an ornamental fashion.

Further, an opening 22 can be seen within the body of the binder clip 10 that creates the tab 20 centrally within the body portion adjacent to the location wherein the top 12 and bottom 14 portion of the body are folded relative to one another. The tab 20 is preferably formed by a relief cut or opening 22 that separates the tab 20 from the surrounding material of the top portion 12 of the binder clip 10. When the binder clip 10 is folded the tab 20 remains straight and extends outwardly from the binder clip 10. The tab 20 preferably includes a hole 24 therein that facilitates hanging of the binder clip 10 and the sheets of paper secured therein. As was stated above with respect to the bottom portion 14 of the binder clip 10, the tab 20 may be formed as depicted at FIG. 4 in a shape selected from the group consisting of: circular, semicircular, triangular, rectangular and free form.

Another feature that may be provided in a preferred embodiment of the binder clip 10 of the present invention are score lines 26 to facilitate bending of the body. Score lines 26 may be provided at the demarcation between the guide legs 18 and the upper portion 12 of the body as well as at the fold line 16 between the top 12 and bottom 14 portions of the body. The score lines 26 may be singular lines or a plurality of spaced apart parallel score lines 26. The purpose of the score lines 26 is to facilitate accurate and easy bending of the binder clip 10 as it is installed onto the stack of paper as will be described below.

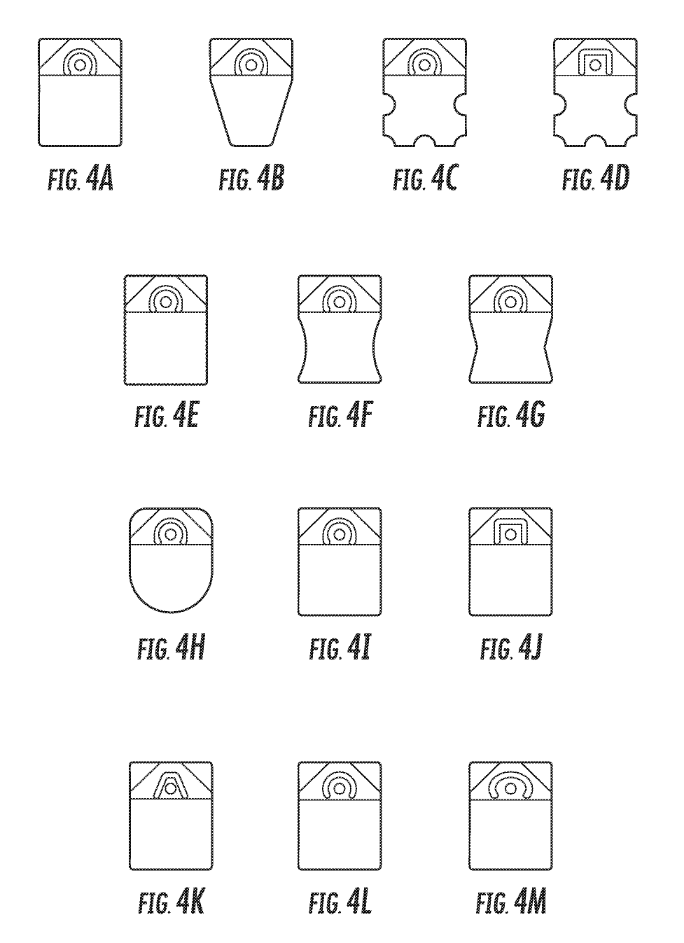

Turning now to FIGS. 2 and 3, the binder clip of the present invention can be seen applied to a plurality of sheets of paper. The stack 28 of paper contains a plurality of sheets of paper having a front sheet 30 and a rear sheet 32. The paper sheets can be seen to be arranged and juxtaposed into a neatly arranged stack such that they are all aligned neatly along one corner of the stack. As can best be seen at FIG. 2, the binder clip 10 is applied so that the corner part 34 of the sheets of paper or documents which have been collected into a plurality of sheets is received within the guide legs 18 as they are bent rearwardly relative to the upper portion 12 of the binder clip 10 body. With the corner 34 of the paper received therein, the guide legs 18 re further bent against the rear surface of the rear sheet 32 such that the upper portion 12 of the binder clip 10 presses the topmost sheet 30 from its top surface side while the pair of guide legs 18 press the lowermost sheet 32 from its back surface. As a result of this bend in the guide legs 18, the interposed documents can be integrally bound without inflicting any damage to them.

Turning to FIG. 3, once the documents are received within the guide legs 18, the top portion 12 is bent rearwardly relative to the bottom portion 14. The top 12 and bottom 14 portion are bent along the fold line 16 thereby trapping and folding the corner 34 of the stack of paper 28 against the bottom of the rear sheet 32 binding the stack therein. The tab 20 can be seen to extend from the bottom portion 14 of the binder clip 10 body at the fold line 16. The tab 20 extends outwardly from the binder clip body when the top portion 12 is bent against the rear sheet of the stack. The tab 20 further can be seen to include a hole 24 or aperture therein to facilitate hanging of the binder clip and the documents bound therein.

The binder clip may be completely encapsulated or coated in a manner that reduces rusting and the resulting discoloration of the papers bound therein. Further, the metallic material itself may be colored. Similarly there may be a colored coating on the material. Still further indicia in the form of personalization a logo or other advertizing indicia may be formed on the binder clip as desired by the end user of the binder clip.

It can therefore be seen that the present invention provides a paper binder clip or paper fastener that functions to hold a substantial number of sheets together in a neat, organized, semi-permanent and secure manner without injuring the documents while facilitating the hanging on a bulletin board or the like. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A paper binding clip for binding a corner of a stack containing a plurality of sheets of paper, the stack having a front sheet and a rear sheet, the binding clip, comprising:
a body formed from a manually bendable metallic material, the body having a top portion, a bottom portion and a fold line therebetween, the body received on top of the front sheet proximate the binding corner;
guide legs extending from the top portion of the body that are bent rearwardly adjacent the corner to engage the bottom of the rear sheet, wherein the top portion is bent rearwardly relative to the bottom portion along the fold line thereby trapping and folding the corner of the stack of paper against the bottom of the rear sheet binding the stack therein; and
a tab extending from the bottom portion of the binder clip body at the fold line, the tab extending outwardly from the binder clip body when the top portion is bent against the rear sheet of the stack.

2. The paper binding clip of claim 1, wherein the tab includes an aperture therein to facilitate hanging the binder clip and the stack of paper retained therein.

3. The paper binding clip of claim 1, the body is formed from a sheet of metal.

4. The paper binding clip of claim 1, the body having indicia printed on a front surface thereof.

5. The paper binding clip of claim 1, wherein the tab is formed by a relief cut that separates the tab from the surrounding material of the top portion of the binder clip.

6. The paper binding clip of claim 1, further comprising:
score lines formed at the fold line and the base of the legs to facilitate bending of the metal.

7. The paper binding clip of claim 1, the bottom portion of the body formed in a shape selected from the group consisting of: circular, semicircular, triangular, rectangular and free form.

8. The paper binding clip of claim 1, the tab formed in a shape selected from the group consisting of: circular, semicircular, triangular, rectangular and free form.

9. A paper binding clip for binding a corner of a stack containing a plurality of sheets of paper, the stack having a front sheet and a rear sheet, the binding clip, comprising:
a body formed from a sheet of manually bendable metallic material, the body having a top portion, a bottom portion and a fold line therebetween, the body received on top of the front sheet proximate the binding corner;
upper corners of the top portion of the body forming guide legs that are bent rearwardly adjacent the corner to engage the bottom of the rear sheet, wherein the top portion is bent rearwardly relative to the bottom portion along the fold line thereby trapping and folding the corner of the stack of paper against the bottom of the rear sheet binding the stack therein;
a tab extending from the bottom portion of the binder clip body at the fold line, the formed by a relief cut that separates the tab from the surrounding material of the top portion of the binder clip, the tab extending outwardly from the binder clip body when the top portion is bent against the rear sheet of the stack; and
an aperture in said tab to facilitate hanging the binder clip and the stack of paper retained therein.

10. The paper binding clip of claim 9, the body having indicia printed on a front surface thereof.

11. The paper binding clip of claim 9, further comprising:
score lines formed at the fold line and the base of the legs to facilitate bending of the metal.

12. The paper binding clip of claim 9, the bottom portion of the body formed in a shape selected from the group consisting of: circular, semicircular, triangular, rectangular and free form.

13. The paper binding clip of claim 9, the tab formed in a shape selected from the group consisting of: circular, semicircular, triangular, rectangular and free form.
